(19) United States
(12) Patent Application Publication
(10) Pub. No.: US 2008/0079537 A1
(43) Pub. Date: Apr. 3, 2008

(54) DOOR HANDLE APPARATUS FOR VEHICLE

(75) Inventor: Hiroshi Touge, Ichinomiya-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/861,685

(22) Filed: Sep. 26, 2007

(30) Foreign Application Priority Data
Sep. 28, 2006 (JP) 2006-264857

(51) Int. Cl. H04Q 1/00

(52) U.S. Cl. 340/5.72

(57) ABSTRACT

A door handle apparatus for a vehicle, which is provided at a vehicle door and is operated when a user of the vehicle conducts opening/closing operation to the vehicle door, includes a piezoelectric element converting an electric signal into an oscillation signal of an ultrasonic wave and converting the oscillation signal of the ultrasonic wave into the electric signal, a resonating member resonating having the piezoelectric element at an inner side thereof, the resonating member being resonated with the piezoelectric element, and a vibration absorbing means provided at an outer side of the resonating member.

### CROSS REFERENCE TO RELATED APPLICATIONS

This application is based on and claims priority under 35 U.S.C. §119 to Japanese Patent Application 2006-264857, filed on Sep. 28, 2006, the entire content of which are incorporated herein by reference.

### FIELD OF THE INVENTION

The present invention relates to a door handle apparatus for a vehicle that is provided to a vehicle door and is operated when a user of the vehicle opens or closes the vehicle door.

### BACKGROUND

It is well known that a control system (smart entry system) detects movement of a user of a vehicle, such as approach of the user to the vehicle or egress of the user from the vehicle, and then the control system controls automatic locking and unlocking operations. The user's locking and unlocking operation is detected by the control system based on the operations applied by the user to a door handle provided at the vehicle door, and then the control system automatically locks or unlocks the vehicle door. For example, the vehicle door is unlocked when the user who remains outside the vehicle is approaching the vehicle and then places one's hand closer to the door handle or touches the door handle in order to operate the door handle.

Door handles used to achieve such a locking control system are disclosed in JP2005098017A and JP2003194959A. The door handle disclosed in JP2005098017A includes a sensor, which detects displacement of a handle main body, provided at a movable portion that is integrally formed with the handle main body. The sensor detects operation applied to the door handle when the movable portion is deformed as a result of pulling the handle main body. The door handle disclosed in JP2003194959A includes a hollow portion in its inside. Sensor electrodes, which function as a human body detecting portion, are accommodated in the hollow portion. The sensor electrodes detect changes in electric capacitance between the electrodes. The changes in electric capacitance between the electrodes are caused when the user holds the door handle (approach of user's hand to the door handle). The approach of the user to the door handle is detected based on the changes of the electric capacitance.

However, the door handle disclosed in JP2005098017A may not detect the user's intention of unlocking the vehicle door unless applying sufficient force to the door handle in order to move the handle main body. On the other hand, the door handle disclosed in JP2003194959A detects the user's intention of unlocking the vehicle door when the user's hand approaches the door handle. However, in some cases, it may be difficult to assure accuracy in detecting the electric capacitance. The electric capacitance may change largely depending on conditions where, for example, the door handle is wet because of rain or dew or where the user contacts the door handle while wearing gloves. Hence, measures to prevent large changes in the electric capacitance under the above-mentioned conditions may be needed.

A need thus exists to provide a door handle apparatus for a vehicle which is not susceptible to the drawback mentioned above.

### SUMMARY OF THE INVENTION

A door handle apparatus for a vehicle, which is provided at a vehicle door and being operated when a user of the vehicle conducts opening/closing operation to the vehicle door, includes a piezoelectric element converting an electric signal into an oscillation signal of an ultrasonic wave, at the same time, the piezoelectric element converting the oscillation signal of the ultrasonic wave into the electric signal, wherein the piezoelectric element is provided at an inner side of the resonating member facing a door panel of the vehicle door, a resonating member resonating with the piezoelectric element, and a vibration absorbing means provided at an outer side of the resonating member.

### BRIEF DESCRIPTION OF THE DRAWINGS

The foregoing and additional features and characteristics of the present invention will become more apparent from the following detailed description considered with reference to the accompanying drawings, wherein:

FIG. 1 is a perspective view illustrating an example of a vehicle door having a handle for a vehicle (or, a vehicular handle) related to a present invention;

FIG. 2 is a cross-sectional view taken along line II-II of FIG. 1;

FIG. 3 is a block diagram schematically illustrating an example of a system configuration of a locking control system;

FIG. 4 is a block diagram schematically illustrating an example of a configuration of an unlocking operation detecting means;

FIG. 5 is a waveform chart schematically illustrating an example of a signal processing executed by the unlocking operation detecting means; and

FIG. 6 is a block diagram schematically illustrating another example of the configuration of the unlocking operation detecting means;

### DETAILED DESCRIPTION

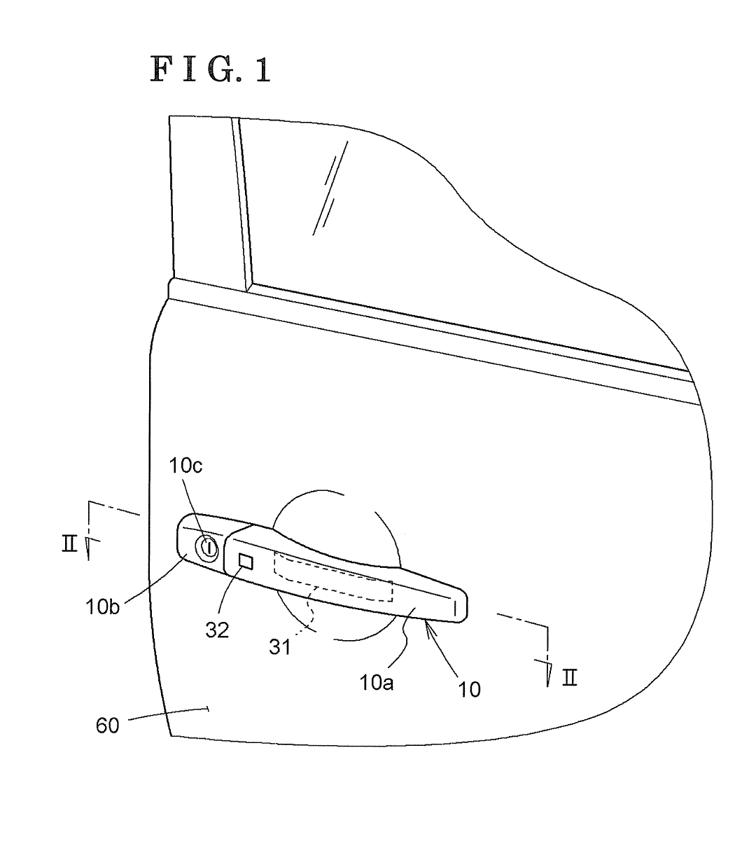

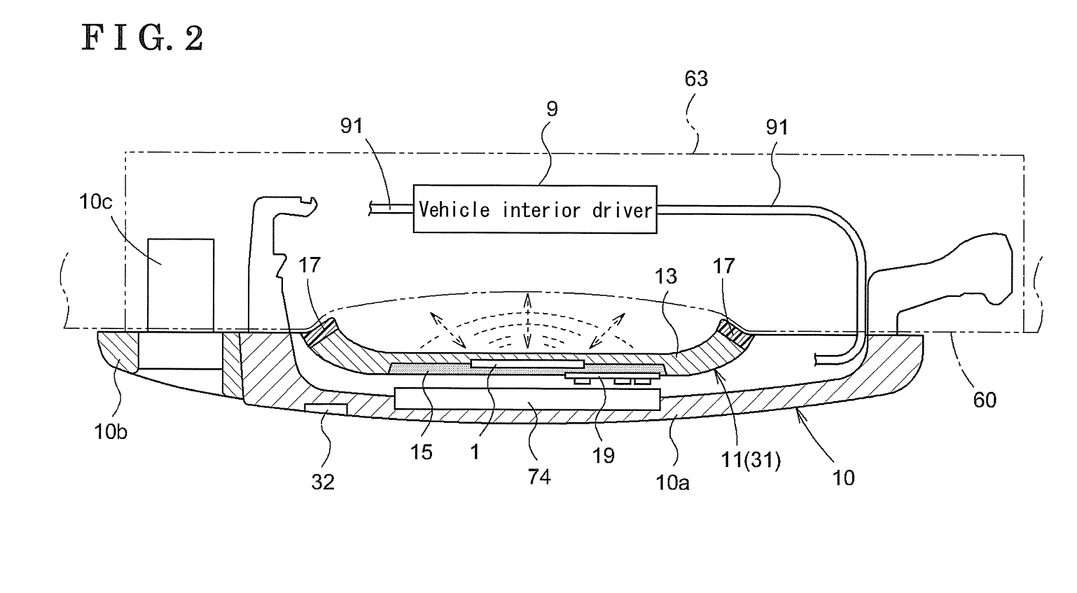

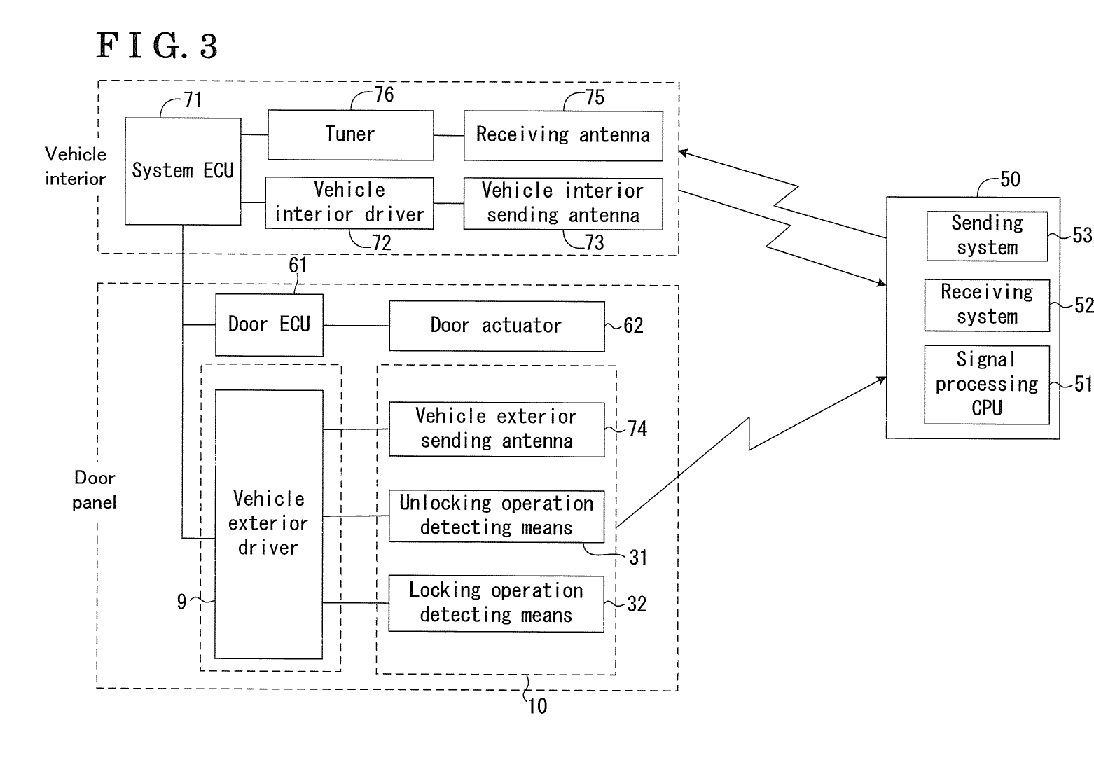

An embodiment of the present invention will be explained in accordance with the attached drawings. In this embodiment, an example in which a door handle apparatus for the vehicle (which is abbreviated as a door handle) is employed for providing a control system, such as a smart entry system, thereof is explained. FIG. 1 is a perspective view illustrating an example of the vehicle door to which the door handle apparatus for the vehicle related to the present invention is applied. FIG. 2 is a cross-sectional view of the door handle apparatus for the vehicle taken along line II-II of FIG. 1. FIG. 3 is a block diagram schematically illustrating an example of a system configuration of the locking control system.

As shown in FIG. 1, a door handle 10 is provided to a door panel 60 of the vehicle door. The door handle 10 functions as an operating portion for opening and closing the vehicle door. Further, the door handle 10 is supported by a handle frame 63 (see FIG. 2) that is provided within the door panel 60 of the vehicle door. The door handle 10 includes an unlocking operation detecting means 31 for detecting a user's unlocking operation, and a locking operation detecting means 32 for detecting the user's locking operation.

### [System Configuration]

FIG. 3 schematically illustrates an example of the system configuration of the locking control system. The locking control system recognizes that the user (e.g., a driver) carrying a portable device 50 approaches the vehicle or moves toward the exterior of the vehicle. Then, the locking control system automatically controls a vehicle door to be locked or unlocked. For example, when the user carrying the portable device 50 approaches the vehicle, the locking control system recognizes the user's approach to the vehicle through a system electric control unit 71 (which is referred to as the system ECU 71) provided at the vehicle. When the user places one's hand on the door handle 10 in order to open the vehicle door, the unlocking operation detecting means 31 recognizes the user's operation of the door handle 10, and the vehicle door is controlled by the unlocking operation detecting means 31 to be automatically unlocked. On the other hand, when the user carrying the portable device 50 moves outside the vehicle, the locking control system recognize user's unloading by the system ECU 71 provided at the vehicle. When the user operates the locking operation detecting means 32 provided to the door handle 10, the unlocking operation detecting means 31 recognizes the user's locking operation and then the vehicle door is automatically locked.

The portable device 50 carried by the user includes a receiving system 52, a sending system 53 and a microprocessor unit 51 (which is, hereinafter, referred to as a MPU 51). Specifically, the receiving system 52 is comprised of, for example, a tuner and an antenna for receiving a radio wave from the vehicle. The sending system 53 is comprised of, for example, a modulation circuit and an antenna for sending a radio wave to the vehicle. The MPU 51 executes a signal processing, such as controlling sending/receiving a signal, determining the signal received by the receiving system 52 and generating the signal sent by the sending system 53.

The system ECU 71, a vehicle interior signal sending antenna 73, a vehicle interior driver 72, a signal receiving antenna 75 and a turner 76 are provided at the vehicle's interior. The system ECU 71 is a control means that executes overall control on the locking control system. Additionally, the system ECU 71 includes a decision means with which the system ECU 71 makes a decision of the approach of the portable device 50 to the vehicle or the displacement of the portable device 50 outside the vehicle by communicating with the portable device 50 that will be described below. The vehicle interior signal sending antenna 73 is an antenna that sends a signal to the portable device 50 within the vehicle interior. The vehicle interior driver 72 is a signal processing circuit in which the vehicle interior driver 72 amplifies or modulates the signal that is sent to the portable device 50 from the vehicle interior signal sending antenna 73. The signal receiving antenna 75 is an antenna that receives a sending signal transmitted from the portable device 50. The tuner 76 is a signal processing circuit in which the tuner 76 detects and demodulates the signal sent from the portable device 50. In addition, when the signal is sent from a vehicle interior signal sending antenna 73 provided at the vehicle to the portable device 50, a carrier wave in the low frequency band (the LF band), for example approximately 125 kHz in the LF band, is applied. When the signal is sent from the portable device 50 to the signal receiving antenna 75 provided at the vehicle, a carrier wave in the ultra high frequency band (the UHF band), for example approximately 310 MHZ in the UHF band, is applied. The above-mentioned antennas, driver, tuner and the like are provided to the locking control system so as to accommodate the frequency ranges.

As shown in FIG. 3, the door handle 10 includes a vehicle exterior signal sending antenna 74, the unlocking operation detecting means 31 and the locking operation detecting means 32. Specifically, the vehicle exterior signal sending antenna 74 sends a signal to the portable device 50. The unlocking operation detecting means 31 and the locking operation detecting means 32 detect a user's operation of the door handle 10. The door handle 10 is supported at the door panel 60 by means of a handle frame 63, and a vehicle exterior driver circuit 9 is provided within the handle frame 63. Signals are transmitted between the vehicle exterior driver circuit 9 and each of the vehicle exterior signal sending antenna 74, the unlocking operation detecting means 31 and the locking operation detecting means 32. Further, within the door panel 60, a door actuator 62 and a door electronic control unit 61 (which is, hereinafter, referred to as a door ECU 61) are provided. Specifically, the door actuator 62 actuates a lock mechanism of the vehicle door in order to lock or unlock the vehicle door, and the door ECU 61 controls the door actuator 62. The door ECU 61 and the vehicle exterior driver circuit 9 are controlled by the system ECU 71.

### [Configuration of Each Component]

As illustrated in FIG. 2, the door handle 10 is supported by the handle frame 63 so that the door panel 60 is located between the door handle 10 and the handle frame 63. Further, a handle main body 10a and a handle cap 10b are supported at the handle frame 63. The handle cap 10b includes a key cylinder 10c that is used when the vehicle door is manually and mechanically locked or unlocked by the user. The vehicle exterior driver circuit 9 is provided inside the handle frame 63, and the vehicle exterior driver circuit 9 is connected to each of the vehicle exterior sending antenna 74, the unlocking operation detecting means 31 and the locking operation detecting means 32 via a wire harness 91, and is further connected to the system ECU 71 provided at the vehicle interior via the wire harness 91.

The vehicle exterior signal sending antenna 74, the unlocking operation detecting means 31 and the locking operation detecting means 32 are provided within the door handle 10. As shown in FIG. 2, the vehicle exterior signal sending antenna 74 is arranged at a middle portion of the door handle 10 in a horizontal direction thereof. The vehicle exterior signal sending antenna 74 is configured with a loop antenna in which, for example, a wire is wound around ferrite. However, the configuration of the vehicle exterior signal sending antenna 74 is not limited on the loop antenna as long as a substitute antenna is arrangeable within the door handle 10 and further the substitute antenna accommodates the frequency range applied for the locking control system.

The unlocking operation detecting means 31 is provided at an inner portion of the door handle 10 so as to face the door panel 60. The locking operation detecting means 32 is provided at an outer portion of the door handle 10 so as not to face the door panel 60. The user pulls the door handle 10 in order to open the vehicle door. At this point, the unlocking operation detecting means 31 detects the user's hand being placed in a space formed between the door handle 10 and the door panel 60. Then the system ECU 71 detects the user's unlocking operation. The unlocking operation detecting means 31 detects the user's unlocking operation by sending an ultrasonic wave signal inwardly from the inner portion of the door handle 10 to the door panel 60. Alternatively, the unlocking operation detecting means 31 detects use's contact to the door handle 10 based on changes in resonance frequency generated at a resonating member 13 that is provided to the door handle 10. Details will be described below. The locking operation detecting means 32 is arranged at the outside of the door handle 10 so that the locking operation detecting means 32 detects pressure or touch of the user's finger (hand) after the user gets out the vehicle and then closes the vehicle door 6. The system ECU 71 detects the user's locking operation when the locking operation detecting means 32 detects the pressure applied to the outer surface of the door handle 10 by the user's finger or the touch of the user's hand to the outer surface of the door handle 10. The locking operation detecting means 32 is configured with, for example a switch.

### [Configuration of the Unlocking Operation Detecting Means]

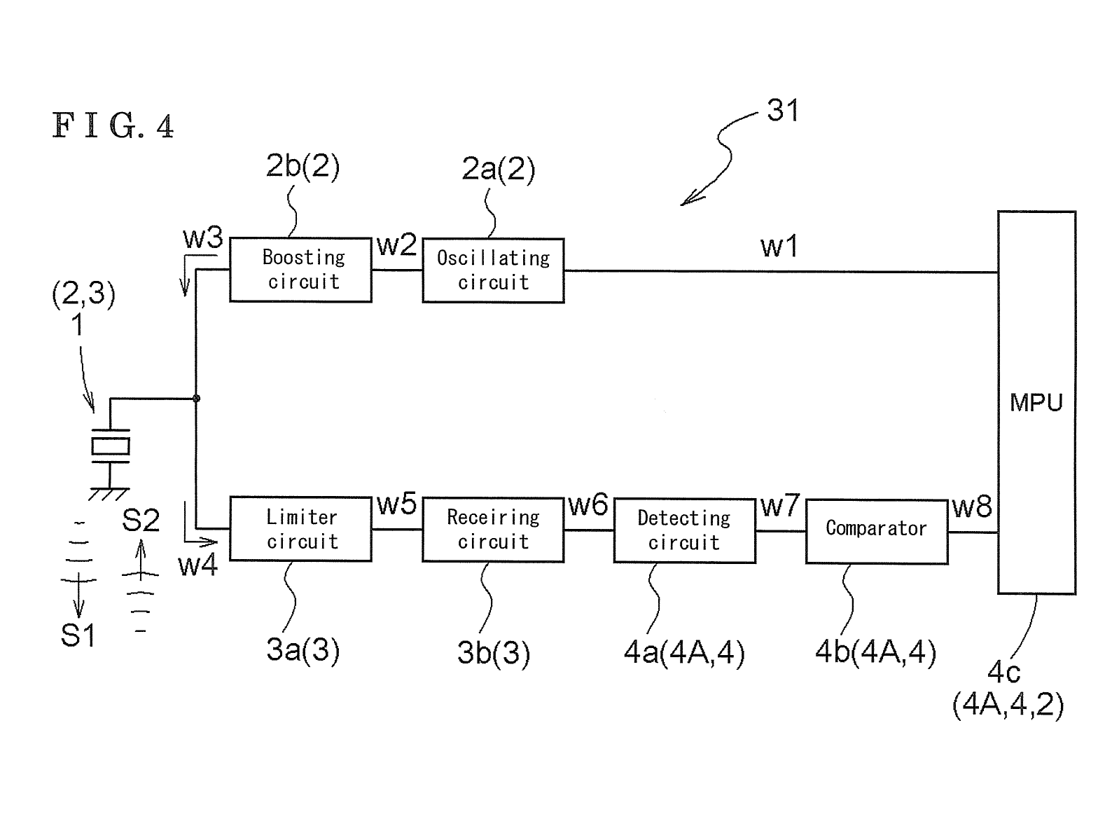

FIG. 4 is a block diagram schematically illustrating an example of the configuration of the unlocking operation detecting means 31. The unlocking operation detecting means 31 is configured with an ultrasonic wave transmitting means 2, an ultrasonic wave receiving means 3 and a detecting means 4. The ultrasonic wave transmitting means 2 transmits the ultrasonic wave signal from the door handle 10 to the door panel 60 of the vehicle door. A reflected wave signal S2 is generated by the transmitted wave signal S1, which is transmitted from the ultrasonic wave transmitting means 2, being reflected by the door pane 60. The ultrasonic wave receiving means 3 receives the reflected wave signal S2. Then the detecting means 4 detects the user's operation of the door handle 10 based on the transmitted wave signal S1 and the reflected wave signal S2.

As shown in FIG. 4, the unlocking operating detecting means 31 includes a microprocessor unit 4c (hereinafter referred to as MPU 4c), an oscillating circuit 2a, a boosting circuit 2b, a piezoelectric element 1, a limiter circuit 3a, a receiving circuit 3b, a detecting circuit 4a and a comparator 4b. The ultrasonic wave transmitting means 2 includes the MPU 4c, the oscillating circuit 2a, the boosting circuit 2b and the piezoelectric element 1. The ultrasonic wave receiving means 3 includes the piezoelectric element 1, the limiter circuit 3a and the receiving circuit 3b. The detecting means 4 includes the detecting circuit 4a, the comparator 4b and the MPU 4c. The MPU 4c, the oscillating circuit 2a, the boosting circuit 2b, the piezoelectric element 1, the limiter circuit 3a, the receiving circuit 3b, the detecting circuit 4a and the comparator 4b will be described later in detail. This configuration is one example of the unlocking operation detecting means 31. Each circuit and the like only indicate distributed function. Therefore, each circuit and the like may not necessarily be physically independent. Moreover, each circuit and the like may not necessarily be limited on hardware, but each function may be achieved with software. In addition, in this embodiment, as an example, the piezoelectric element 1 is adopted in order to execute conversion between the ultrasonic wave signal and an electric signal, but other elements may be adopted to achieve the conversion between the ultrasonic wave signal into the electric signal.

The ultrasonic wave transmitting means 2 and the ultrasonic wave receiving means 3 include the piezoelectric element 1 that converts the electric signal into the ultrasonic wave signal and vice versa. In this embodiment, the identical piezoelectric element 1 serves both as the ultrasonic wave transmitting means 2 and the ultrasonic wave receiving means 3, however each of the ultrasonic wave transmitting means 2 and the ultrasonic wave receiving means 3 may respectively include a piezoelectric element.

The piezoelectric element 1 is provided at an inner member 11 of the door handle main body 10a as shown in FIG. 2 in order to propagate the ultrasonic wave signal from the ultrasonic wave transmitting means 3 towards the door panel 10. Along with the piezoelectric element 1, the inner member 11 includes a resonating member 13 and a supporting member 17. The resonating member 13 configures a resonance system together with the piezoelectric element 1. Further, the resonating member 13 is made of metal, such as aluminum. The supporting member 17 supports the resonating member 13 that generates vibration corresponding to the ultrasonic wave signal together with the piezoelectric element 1. Joint portions between the resonating member 13 and the supporting member 17 function as fulcrums when the resonating member 13 is vibrated sympathetically at a natural frequency formed by the resonating member 13 and the piezoelectric element 1. Therefore, the supporting member 17 has a function of blocking the vibration of the resonating member 13 and preventing the vibration generated at the resonating member 13 from being directly propagated to the door panel 60.

Furthermore, the piezoelectric element 1 is provided at an inner portion of the resonating member 13 so that the piezoelectric element 1 faces the door panel 60. In other words, because the piezoelectric element 1 is made of, for example, a ceramic material having piezoelectricity and a composite material including the ceramic material having the piezoelectricity, the piezoelectric element 1 is provided nearer to an inner surface of the resonating member 13 facing the door panel 60. Silicon rubber is filled in an outer surface of the resonating member 13 (the surface that does not face the door panel 60) so that the silicon rubber covers the piezoelectric element 1. The silicon rubber fillings functions as a vibration absorbing means 15. The above-mentioned configuration of the inner member 11 provides directivity to the ultrasonic wave signal transmitted as a result of the vibration generated by the piezoelectric element 1 and the resonating member 13 so that the ultrasonic wave signal is transmitted only to the door panel 60 from the door handle 10. Specifically, because of the directivity of the transmitted ultrasonic wave signal toward the door panel 60, the ultrasonic wave signal is restrained from being transmitted outwardly from the door handle 10 (outwardly from the vehicle body). As a result, most of the ultrasonic wave signal is transmitted from the door handle 10 to the door panel 60.

A circuit board 19 is provided at an outer side of the inner member 11, for example, on the vibration absorbing means 15. Circuits of the unlocking operation detecting means 31 shown in FIG. 4 are provided on the circuit board 19. Additionally, all of circuits shown in FIG. 4 may not necessarily be provided to the circuit board 19, but some of the circuits may be provided on the circuit board. For example, the function of the MPU 4c may be included to the vehicle exterior driver circuit 9 or the system ECU 71.

### [Signal Processing]

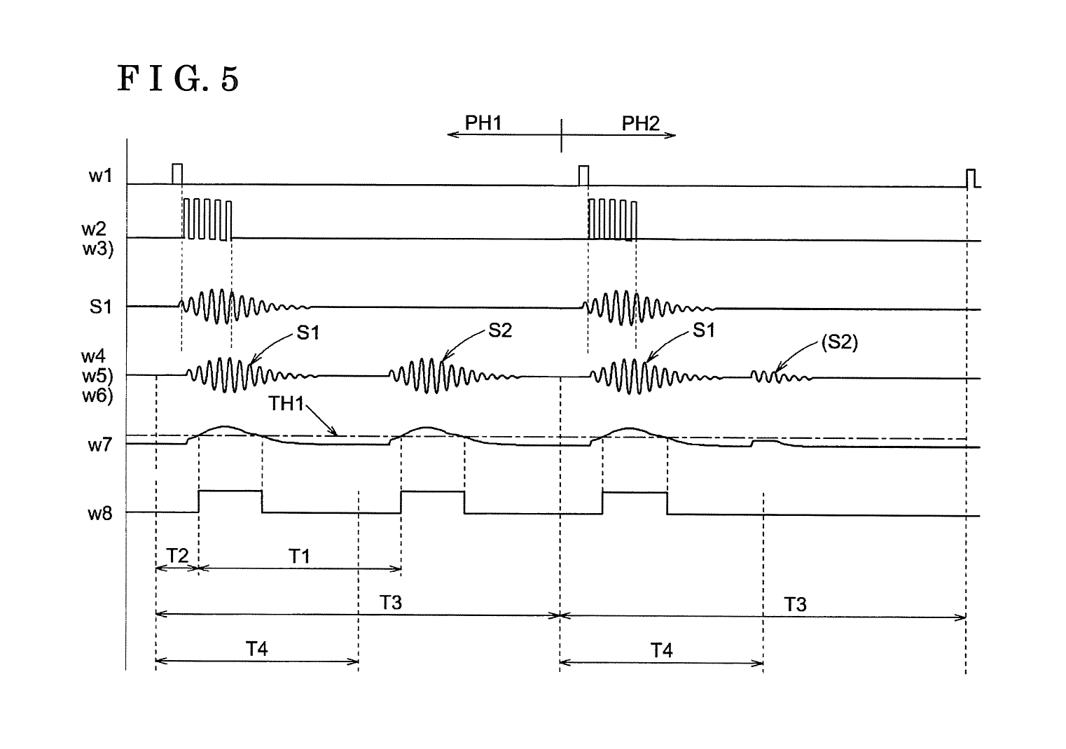

FIG. 5 is a timing chart that schematically shows timing of the transmitted wave signal S1 being transmitted and the reflected wave signal S2 being received by the unlocking operation detecting means 31. The signal processing implemented by the unlocking operation detecting means 31 will be described below in accordance with FIG. 5.

### (Sending Process)

The MPU 4c sends a command (an oscillation command) for driving the transmitted wave signal S1 at predetermined time intervals. For example, as shown in FIG. 5, the MPU 4c sends the oscillation command signal at every time interval T3. The oscillation command signal is inputted to the oscillating circuit 2a as a signal w1. The oscillating circuit 2a configured with a resistance-capacitance oscillating circuit (RC oscillating circuit) and the like generates an oscillating signal w2 at several cycles with a predetermined oscillating frequency. For example, the time interval T3 is set approximately to 1 to 2 milliseconds, and the oscillating frequency of the oscillating circuit 2a is set approximately to 60 kHz and the number of cycles of the oscillating frequency of the oscillating circuit 2a is set to about four cycles. Then, the oscillating signal w2 of 3.3 to 5 V is boosted up approximately to 60 V at the boosting circuit 2b that includes a coil and the like in order to oscillate the piezoelectric element 1. A boosted oscillation signal w3 oscillates the piezoelectric element 1. The piezoelectric element 1 forms mechanical resonance system together with the resonating member 13, and the ultrasonic wave signal (transmitted wave signal S1) corresponding to the resonance frequency generated at the resonance system is propagated from surfaces of the resonating member 13.

As described below, in this embodiment, the user's operation of the door handle 10 is detected based on changes in propagating time between a time when the ultrasonic wave signal, which reciprocates between the door handle 10 and the door panel 60, is propagated and a time when the ultrasonic wave signal is received. Therefore, when the resonance system has a longer vibration continuing time until the vibration is ceased, a vibration continuing time, which is the vibration remains after the transmitted wave signal S1 is transmitted, it overlaps at the beginning of the reflected wave signal S2. As a result, it becomes difficult to determine a receiving time of the reflected wave signal S2 from, and therefore, reciprocation of the ultrasonic wave between the door handle 10 and the door panel 60 may not be accurately determined. Consequently, in order to shorter the vibration continuing time, cycles of burst oscillation of the oscillating signal w2 generated at the oscillating circuit 2a is set approximately to four cycles. Time chart of the oscillating signal w2 generated at the oscillating circuit 2a and the transmitted signal S1 vibrated by the oscillating circuit 2a is also shown in FIG. 5. As shown in FIG. 5, the oscillating signal w2 has a rectangular wave with a natural frequency determined by the resonance system and the transmitted signal S1 has a delay time to the vibration saturated state and an attenuating time to the vibration interrupted state according to the magnitude of the Q factor. For example, when distance between the door handle 10 and the door panel 60 is set to 34 mm, and when speed of sound is set to 340 m/s, time the ultrasonic wave signal takes to reciprocate between the door handle 10 and the door panel 60 is 0.2 milliseconds. Considering a case where an object, such as the user's hand, is inserted into the space formed by the door handle 10 and the door panel 60, the vibration continuing time may better be set less than half the time the ultrasonic wave signal reciprocating between the door handle 10 and the door panel 60, that is to say, the reverberation time of the transmitted wave signal S1 may better be set about 0.1 milliseconds. With respect to the vibration at the resonance system, the Quality factor (the Q factor) that indicates sharpness of resonance may be set to be lower than the Q factor of the oscillation generally used to send the ultrasonic wave signal. That is because the propagation distance that the ultrasonic wave signal reciprocates between the door panel 60 and the door handle 10 is as short as 68 mm. Therefore priority is given to shortening the vibration continuing time even though the intensity of the transmitted wave signal S1 is decreased. For example, in a case where eight cycles of the burst oscillation pulse having the typical Q factor at the frequency of 60 kHz is used, 0.1 milliseconds of the vibration continuing time is generated. In this embodiment, the Q factor is set to be low and further, sending time of the burst oscillation pulse is set to correspond to about four cycles of the frequency. As a result, the vibration continuing time becomes lower than 0.05 milliseconds.

When the Q factor is high, the transmitted sound pressure for transmitting the ultrasonic wave signal becomes high, and as a result, the ultrasonic wave signal will be transmitted farther. However, the vibration continuing time to vibration-interrupted state generally becomes longer when the Q factor is set high. In this embodiment, distance of one way from the door handle 10 and the door panel 60 is set to little distance of 30 to 40 mm. Hence, priority is given to shortening the vibration continuing time.

In this embodiment mentioned above, the oscillating signal w2 is generated by the burst oscillation at the oscillating circuit 2a based on the oscillation command signal transmitted from the MPU 4c. However, for example, the burst oscillation pulse may be formed at the MPU 4c and then be applied to the piezoelectric element 1 directly from the MPU 4c via the boosting circuit 2b. Additionally, in the case where the burst oscillation pulse is applied directly to the piezoelectric element 1 from the MPU 4c, the burst oscillation pulse is not routed through an oscillating circuit 2a, which is configured with an analog circuit. Therefore, a single pulse may be adopted and directly applied to the piezoelectric element 1 from the MPU 4c. Furthermore, generation of the vibration continuing time on the transmitted wave signal S1 may be shortened. The time intervals for transmitting the ultrasonic wave signal are set to 1 to 2 milliseconds. Considering that the time the ultrasonic wave signal takes to reciprocate between the door handle 10 and the door panel 60 is equivalent to 0.2 milliseconds, 1 to 2 milliseconds time intervals for transmitting the ultrasonic wave signal is long enough not to receive multiple reflected signals or irregular reflection signal generated between the door handle 10 and the door panel 60. As a result, accurate detection of the object, such as the hand of the user, will be achieved. As mentioned above, it is obvious that, for example, numbers of the burst oscillation pulse and time intervals (T3) for transmitting the ultrasonic wave vary depending on applications, such as distance between the door handle 10 and the door panel 60. Hence, those numerical values mentioned above are not limited to the embodiment.

### (Receiving Process)

The ultrasonic wave receiving means 3 receives the reflected wave signal S2 of the transmitted wave signal S1 transmitted from the ultrasonic wave transmitting means 2, at the same time, the ultrasonic wave receiving means 3 inputs the transmitted wave signal S1 (the oscillation signal w3). In this embodiment, sending the transmitted wave signal S1 and receiving the reflected wave of the S2 are implemented with the one identical resonating member 13, therefore, the high-voltage oscillation signal w3 is inputted to the ultrasonic wave receiving means 3 as a signal w4. Hence, the limiter circuit 3a putting a limitation to the voltage of the signal w4 being within the limits of the allowable input voltage of the receiving circuit 3b is provided at a first stage of the ultrasonic wave receiving means 3. The signal processing is executed to a signal w5, which is transmitted through the limiter circuit 3a, at the receiving circuit 3b that implements, for example, impedance conversion and filtering, and then the signal w5 is outputted to the detecting means 4.

### (Detecting Process)

At the detecting circuit 4b, for example, envelope detection is executed to a signal w6, which is outputted from the ultrasonic wave receiving means 3. A detected signal w7 is pulsed by implementing a threshold processing, which has a predetermined threshold TH1, at the comparator 4b. Finally, a pulsed signal w8 is inputted to the MPU 4c.

As mentioned above, both the transmitted wave signal S1 and the reflected wave signal S2 are included in the signals w4, w5, w6, w7 and w8. T1 shown in FIG. 5 indicates time difference between a time when the transmitted wave signal S1 is transmitted and a time when the reflected wave signal S2 is received. The T1 corresponds to an approximate time in which the ultrasonic wave signal reciprocates between the door handle 10 and the door panel 60. When the MPU 4c receives a pulse signal w8 after time interval T2 has passed since the MPU 4c had sent the oscillating command signal (the sending commend) and then the MUP 4c receives other signal w8 after the further time interval T1 has passed, the MPU 4c recognizes that the reflected wave signal S2 is generated. On the other hand, it is obvious that the transmitted wave signal S1 is always generated, therefore, MPU 4c may determine the generation of the reflected wave signal S2 in a following manner. When the MPU 4c receives the input signal w8 while the time T4 has passed since the MPU 4c transmitted the oscillating command signal and the MPU 4c transmits the next oscillating command, the MPU 4c recognizes the received signal as that the reflected wave signal S2.

As illustrated at the left half of FIG. 5 showing a case of PH 1, when the MPU 4c detects the reflected wave signal S2 during the time internal T3, the MPU 4a determines that there is no object blocking the ultrasonic wave from reciprocating between the door handle 10 and the door panel 60. In other words, the MPU 4c determines that no operation is applied to the door handle 10 by the user of the vehicle.

A case PH 2 where the reflected wave signal S2 is not determined during the time interval T3 is illustrated at the right half of FIG. 5. The pulse corresponding to the transmitted wave signal S1 is inputted to the MPU 4c, but the pulse corresponding to the reflected wave signal S2 is not inputted into the MPU 4c. In this case, the MPU 4c determines that there is an object blocking the ultrasonic wave from reciprocating between the door handle 10 and the door panel 60. In other words, the MPU 4c recognizes that user's hand is inserted into the space formed by the door handle 10 and the door panel 60, therefore, the MPU 4c determines that the operation is applied to the door handle 10 by the user of the vehicle.

When the user's hand is inserted into the space formed by the door handle 10 and the door panel 60, in other words, when the ultrasonic wave signal is intercepted from reciprocating between the door handle 10 and the door panel 60 by means of the user's hand, the reflected wave signal S2 is not received by the ultrasonic wave receiving means 3. On the other hand, when the transmitted wave signal S1 is reflected by the user's hand, the reflected wave signal S2 may be generated. However, in this case, most of the transmitted wave signal S1 is absorbed by the user's hand. Therefore, signal intensity of the reflected wave signal S2 being deflected by the user's hand is decreased comparing to the signal intensity of the reflected wave signal S2 generated by the transmitted wave signal S1 being reflected by the door panel 60. Hence, by setting the threshold TH1 of the comparator 4b at an appropriate value, the detected signal w7 does not exceed the threshold TH1. As a result, the reflected wave S 2 is not determined by the MPU 4c when the user's hand is inserted into the space formed by the door handle 10 and the door panel 60. Further, when there is an object that does not absorb the reflected wave signal S1 exists between the door handle 10 and the door panel 60, more specifically, for example, when an icicle is formed on the door handle 10 or when an insect happens to exist between the door handle 10 and the door panel 60, the signal intensity of the reflected wave signal S2 is relatively increased. As a result, the detected signal w7 may exceed the threshold TH1, and the reflected wave signal S2 may be detected by the MPU 4c. However, comparing to the reflected wave signal S2 generated by the transmitted wave signal S1 being reflected by the door panel 60, the transmitted wave signal S1 is reflected at shorter distance when the transmitted wave signal S1 is reflected by the above-mentioned non-absorbing objects. Therefore, the time interval T1 becomes shorter. Hence, by measuring the time of the time interval T1, the MPU 4c determines if the reflected wave signal S2 is generated by the door panel 60 or by the other objects. Additionally, the MPU 4c may determines the existence of the reflected wave signal S2 by confirming the existence of the reflected wave signal S2 after the time interval T4 has passed, instead of measuring the time interval T1.

As described above, according to the embodiment of the present invention, the operation of the user to the door handle 10 is detected by the MPU 4c determining the existence of the reflected wave signal S2 or by the MPU 4c measuring the time interval T1 that corresponds to the time interval between a time when the transmitted wave signal S1 is transmitted and a time when the reflected wave signal S2 is received. Hence, the detecting means 4 of the unlocking operation detecting means 31 may be configured to include a non-contact type detecting means 4A that detects operation applied to the door handle 10 by the user based on detecting existence of the reflected waves S2 generated by the transmitted wave signal S1 being reflected by the door panel 60, and based on measuring the time interval T1 that corresponds to the time interval between the time when the transmitted wave signal S1 being transmitted and the time when the reflected wave signal S2 being received. The configuration of the detecting means 4 may be modified so as to include a contact type detecting means 4B, which will be described below, instead of, or in addition to the non-contact type detecting means 4A.

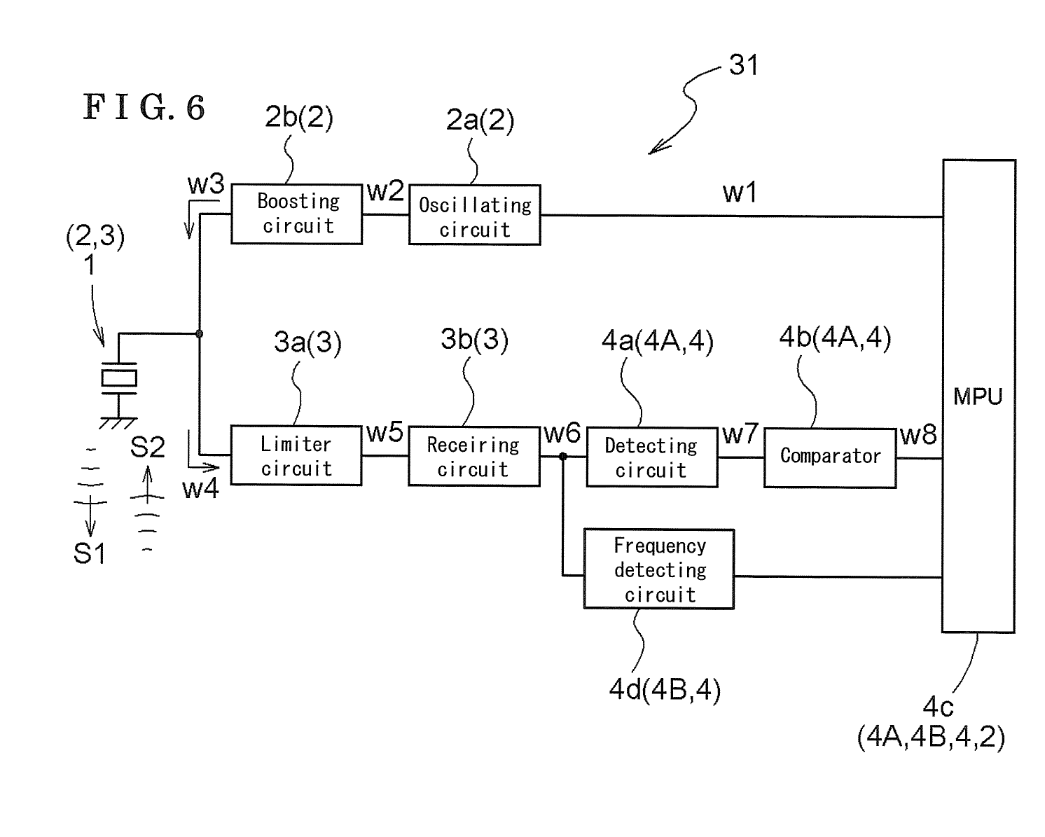

FIG. 6 is a block diagram that schematically illustrates another example of the configuration of the unlocking operation detecting means 31. The detecting means 4 illustrated in FIG. 6 includes, together with the non-contact type detecting means 4A, the contact type detecting means 4B that detects contact of the user to the door handle 10 based on changes of the resonance frequency. When the user's hand contacts the door handle 10, more specifically, when the user's hand contacts the inner member 11, the resonance frequency generated at the resonating member 13 changes. Therefore, the contact type detecting means 4B is configured to include a frequency detecting circuit 4d that outputs a detected result of the changes of the resonance frequency detected by the contact type detecting means 4B to the MPU 4c. When the user contacts the door handle 10, the resonance frequency of the resonance system changes. The resonance system is formed by the resonating member 13 and the piezoelectric element 1. As the oscillating frequency at the oscillating circuit 2a is fixed, signal level of the oscillation signal w2 generated at the oscillating circuit 2a is decreased depending on changes of the resonance frequency. Additionally, the signal level of the oscillating signal w2 is further decreased when the user directly contacts the resonating member 13, because resonance level of the resonance generated by the resonating member 13 and the piezoelectric element 1 changes, in addition to the changes in resonance frequency. Furthermore, when the user's hand blocks a propagation path of the ultrasonic wave signal, the signal level of the reflected wave signal S2 is also decreased. Hence, in this embodiment, the resonance frequency detecting circuit 4d is employed for calculating such changes in the frequency by integrating the signal levels of the transmitted wave signal S1 and the reflected wave signal S2 so that the MPU 4c easily detects the user's operation to the door handle 10. The MPU 4c determines the changes of the resonance frequency and then determines that the operation of the user to the door handle 10. The resonance frequency detecting circuit 4d is configured to detect frequency, for example, based on levels of voltage that is calculated by integrating the transmitted wave signal S1 and the reflected wave signal S2. Furthermore, when user directly holds the inner member 11 of the door handle 20, the oscillation of the transmitted wave signal S1 is absorbed by the user's hand. As a result, because the reflected wave signal S2 is not generated, the MPU 4c determines the user's operation of the door handle 10 in the above-mentioned case.

In this embodiment, as illustrated in FIG. 2, the piezoelectric element 1 is provided at a substantially center of a bottom of the inner member 11 (resonating member 13) formed in a substantially bathtub-shape. However, the position of the piezoelectric element 1 is not limited to the position illustrated in FIG. 2, but the piezoelectric element 1 may be provided at a position shifted away from the central portion of the bottom of the inner member 11. In a case where the piezoelectric element 1 is provided at the position shifted away from the central portion of the bottom of the inner member 11, influence of multiple reflected signals may be reduced. Additionally, the time interval the reflected wave signal S2 travels back to the door handle 10 may be set longer depending on the distance between the door panel 60 and the door handle 10. hI this case, the detecting means 4 may detect the user's operation of the door handle 10 and the position the user's hand is about to be placed.

### [Locking/Unlocking Operation of Locking Control System]

The locking/unlocking operation of the control system using the door handle 10 of the embodiment will be described below.

### (Unlocking Operation)

While the vehicle is parked, and the vehicle door is locked, the system ECU 71 regularly outputs a request signal to the vehicle exterior driver circuit 9 provided within the door panel 60 in order to recognize the portable device 50 functioning as an electronic key registered to the vehicle. An amplifier for sending (not shown) in the vehicle exterior driver circuit 9 modulates and amplifies the request signal. Then, the modulated and amplified signal is sent as a radio wave from the vehicle exterior sending antenna 74 provided at the door handle 10 to the outside of the vehicle. At this point, when the portable device 50 comes close to the vehicle, the receiving system 52 of the portable device 5 receives the radio wave sent from the vehicle exterior sending antenna 74. Then, the portable device 50 executes a signal processing for the received signal at the MPU 51 and sends return information by means of the sending system 53. Specifically, the return information includes a characteristic of the received signal, a registered code and the like. More specifically, the characteristic includes information indicating where the received signal comes from, for example from the vehicle exterior sending antenna 74. At the vehicle side, the signal sent from the portable device 50 as a radio wave is received by the tuner 76 via the receiving antenna 75. Then, the system ECU 1 confirms the characteristic, the registered code and the like included in the return information and recognizes that the portable device 50 functioning as the electronic key and registered for the vehicle is approaching the vehicle.

After the system ECU 1 recognizes the portable device 5, the system ECU 71 enters an unlocking mode. During the unlocking mode, the command of the system ECU 71 is transmitted to the MPU 4c of the unlocking operation detecting means 31. When the MPU 4c receives the command from the system ECU 71, the MPU 4c executes the above-mentioned sending, receiving and detecting process. When the system ECU 1 receives no detecting signal from the unlocking operation detecting means 31 in the predetermined time, or when the communication between the system ECU 1 and the portable device 50 is lost, the system ECU 1 cancels the command to the unlocking operation detecting means 31, and then the system ECU 1 ends the unlocking mode.

During the unlocking mode, when the user executes the unlocking operation, such as by placing one's hand on the door handle 2, the unlocking operation detecting means 31 detects the unlocking operation and sends the detection signal to the system ECU 1 via the vehicle exterior driver circuit 9. Then, the system ECU 1 instructs the unlocking control to the door ECU 61 on the basis of the detection signal and controls the door actuator 62 to drive so as to unlock the vehicle door 6. In other words, the vehicle door is unlocked when the detecting means 4 (the non-contact type detecting means 4A) of the unlocking detecting means 31 detects that the user carrying the portable device 50 is about to place one's hand on the door handle 10, or when the detecting means 4 (the contact type detecting means 4B) of the unlocking detecting means 31 detects that the user carrying the portable device 50 contacts the door handle 10.

### (Locking Operation)

When the user stays within the vehicle, the portable device 50 (electronic key) carried by the user also exists in the vehicle's interior. In this situation, the portable device 50 receives the request signal modified and amplified by the vehicle interior driver 72 provided within the vehicle's interior and sent by the vehicle interior sending antenna 73 provided at the vehicle's interior. The portable device 50 executes the signal processing to the received signal at the MPU 51 and sends return information via the sending system 53. The return information includes a characteristic of the received signal, the registered code and the like. The radio wave of the signal sent by the portable device 50 is received by the tuner 71 via the receiving antenna 75, and the system ECU 1 confirms the return information and recognizes that the portable device 50 exists in the vehicle interior.

In this condition, when the user carrying the portable device 50 gets out of the vehicle and closes the vehicle door, the above-mentioned communication is ended, and the system ECU 71 recognizes that the portable device 50 is moved outside the vehicle. In addition to the above-mentioned operation, as described at the unlocking operation, the system EUC 71 may be modified so as to recognize the establishment of the communication between the portable device 50 and the vehicle exterior sending antenna 74 that sends the sending signal outside the vehicle. When the system ECU 71 recognizes that the user gets off the vehicle or the vehicle door is closed, the system ECU 71 enters the locking anode. When the system ECU 1 receives no detecting signal from the unlocking operation detecting means 31 in the predetermined time, or when the system ECU 1 recognizes that the portable device 50 is brought inside the vehicle's interior, the system ECU 1 ends the locking mode. When the detecting signal is inputted to the system ECU 1 from the locking operation detecting means 32 while the system ECU 71 executes the locking mode, the system ECU 71 sends the locking control signal to the door ECU 61. The door ECU 61 controls the door actuator 62 to be driven, and then the vehicle door is locked.

As described above, according to the embodiment of the present invention, the door handle accurately detects the approach or the contact of the user's hand accompanying the user's operation of the door handle 10. Hence, the locking control system for a highly convenient vehicle door using the door handle 10 is provided for the vehicle.

According to the embodiment of the present invention, the door handle 10, which faces the door panel 60 is configured to include the resonating member 13. Therefore, the ultrasonic wave is efficiently sent to the door panel 50 from the door handle 10. Moreover, because the piezoelectric element 1 is provided at the inner side of the resonating member 13, the ultrasonic wave is efficiently sent to the door panel 60 from the door handle 10. Further, the vibration absorbing means 15 is provided at the outer side of the resonating member 15, as a result, the leakage of the ultrasonic wave in directions other than to the door panel 60 is restricted. Hence, disturbance of the ultrasonic wave is restricted, the ultrasonic wave signal steadily reciprocates between the door handle 10 and the door panel 60, as a result, the ultrasonic wave is accurately sent to the door panel 60 and is received at the door handle 10.

According to the embodiment of the present invention, the door handle apparatus for the vehicle includes a detecting means for detecting the user's operation of the door handle apparatus for the vehicle based on changes of resonance frequency of the resonating member.

When the user touches the door handle apparatus for the vehicle to operate the door handle apparatus for the vehicle, the user's hand forms the resonance system together with the resonating member 13, which leads to changes in a mass of the resonance system. As a result, frequency of the transmitted wave signal S1 and the reflected wave signal S2 changes. The changes of the frequency is not influenced by waterdrops and the like on the door handle apparatus for the vehicle, and as a result, accurate detection of the user's operation will be achieved.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. A door handle apparatus for a vehicle, which is provided at a vehicle door and is operated when a user of the vehicle conducts opening/closing operation to the vehicle door, comprising:
a piezoelectric element converting an electric signal into an oscillation signal of an ultrasonic wave and converting the oscillation signal of the ultrasonic wave into the electric signal;
a resonating member resonating having the piezoelectric element at an inner side thereof, the resonating member being resonated with the piezoelectric element; and
a vibration absorbing means provided at an outer side of the resonating member.

2. The door handle apparatus for the vehicle according to claim 1, wherein an ultrasonic wave signal is transmitted towards the door panel from the resonating member, and the door handle apparatus for the vehicle further comprises a detecting means for detecting the user's contacting operation to the door handle apparatus of the vehicle based on receiving time when the transmitted ultrasonic wave is received by the resonating member.

3. The door handle apparatus for the vehicle according to claim 1, wherein the door handle apparatus for the vehicle includes a detecting means for detecting the user's operation of the door handle apparatus for the vehicle based on changes of resonance frequency of the resonating member.
